(19) United States
(12) Patent Application Publication
(10) Pub. No.: US 2020/0170437 A1
(43) Pub. Date: Jun. 4, 2020

(54) COOKING DEVICE AND COMPONENTS THEREOF

(71) Applicant: SHARKNINJA OPERATING LLC, Needham, MA (US)

(72) Inventors: Joshua D. Anthony, Billerica, MA (US); Christopher Martin, North Attleboro, MA (US); Chad P. Woodrow, Somerville, MA (US)

(21) Appl. No.: 16/784,876

(22) Filed: Feb. 7, 2020

Related U.S. Application Data
(60) Provisional application No. 62/803,336, filed on Feb. 8, 2019.

(51) Int. Cl. A47J 27/00; A47J 27/04; A47J 37/06; A47J 36/06; A47J 36/16; H05B 3/00; H05B 6/12

(52) U.S. Cl. CPC A47J 27/004; A47J 27/04; A47J 37/0641; A47J 36/06; A47J 2027/043; H05B 3/00; H05B 3/0076; H05B 6/12; A47J 36/16

(57) ABSTRACT

A cooking system for cooking food, the cooking system includes a housing having a hollow interior and a lid movable relative to said housing. The lid and housing cooperate to form a cooking chamber. A liquid source for delivering liquid to said cooking chamber during operation of the cooking system and a heating element mounted within the lid. The heating element is operable to transform said liquid into a vapor during operation of the cooking system.

### CROSS REFERENCE TO RELATED APPLICATIONS

This application claims the benefit of U.S. Provisional Application Ser. No. 62/803,336, filed Feb. 8, 2019, the entire disclosure of which is incorporated herein by reference.

### BACKGROUND

Embodiments of the present disclosure relate generally to a cooking device and components thereof, and more specifically, a multifunction device configured to perform the operation of a plurality of distinct cooking devices, the multifunctional cooking device optionally employing various components for cooking in the distinct cooking modes.

Conventional cooking devices, such as pressure cookers and air fryers each perform a single cooking operation, and as such, these devices employ different components and method for cooking food items. As such, multiple devices are required to perform various cooking operations. For consumers that wish to enjoy food cooked in different ways via different operations, an accumulation of these devices can occur. Such an accumulation of cooking devices is often prohibitive from a standpoint of cost and storage space. For at least these reasons, it would be desirable to integrate the functionality of several cooking devices into a single user-friendly cooking device.

### SUMMARY

According to an embodiment, a cooking system for cooking food, the cooking system includes a housing having a hollow interior and a lid movable relative to said housing. The lid and housing cooperate to form a cooking chamber. A liquid source for delivering liquid to said cooking chamber during operation of the cooking system and a heating element mounted within the lid. The heating element is operable to transform said liquid into a vapor during operation of the cooking system.

In addition to one or more of the features described above, or as an alternative, in further embodiments said liquid source is external to said housing and said lid.

In addition to one or more of the features described above, or as an alternative, in further embodiments said liquid source includes a reservoir mountable to at least one of said housing and said lid.

In addition to one or more of the features described above, or as an alternative, in further embodiments said liquid source is a fluid line integrated within a building.

In addition to one or more of the features described above, or as an alternative, in further embodiments said liquid is water.

In addition to one or more of the features described above, or as an alternative, in further embodiments said cooking system is operable in a plurality of cooking modes including a first cooking mode and a second cooking mode, wherein said first cooking mode is a wet cooking mode and said second cooking mode is a dry cooking mode.

In addition to one or more of the features described above, or as an alternative, in further embodiments in said first cooking mode, said liquid is transformed into a vapor during operation of the cooking system.

In addition to one or more of the features described above, or as an alternative, in further embodiments in said first cooking mode, the cooking system is operable as a steam cooker.

In addition to one or more of the features described above, or as an alternative, in further embodiments in said second cooking mode, said heating element heats a flow of air circulating within the cooking chamber.

In addition to one or more of the features described above, or as an alternative, in further embodiments in said second cooking mode, the cooking system is operable as an air fryer.

In addition to one or more of the features described above, or as an alternative, in further embodiments said heating element is operable in both said first cooking mode and said second cooking mode.

In addition to one or more of the features described above, or as an alternative, in further embodiments said heating element is a convective heating element.

In addition to one or more of the features described above, or as an alternative, in further embodiments said heating element is a conductive heating element.

In addition to one or more of the features described above, or as an alternative, in further embodiments said heating element is a radiative heating element.

In addition to one or more of the features described above, or as an alternative, in further embodiments said heating element is an inductive heating element.

According to another embodiment, a method for cooking food in a cooking system includes providing a housing having with a hollow interior, providing a lid movable relative to said housing, said lid and said housing cooperating to form a cooking chamber, providing a heating element associated with said lid, supplying a liquid to the cooking chamber during operation of the cooking system, and converting said liquid supplied to said cooking chamber into a vapor using said heat from said heating element during operation of the cooking system.

In addition to one or more of the features described above, or as an alternative, in further embodiments comprising providing a liquid source external to said housing and said lid.

In addition to one or more of the features described above, or as an alternative, in further embodiments delivering said liquid to said cooking chamber includes pumping liquid from a liquid source to said cooking chamber.

In addition to one or more of the features described above, or as an alternative, in further embodiments delivering said liquid to said cooking chamber includes liquid flowing from said liquid source to said cooking chamber via gravity.

In addition to one or more of the features described above, or as an alternative, in further embodiments comprising circulating said vapor through said cooking chamber to cook food in the cooking system.

According to yet another embodiment, a cooking system for cooking food includes a housing having a hollow interior; and a heating element for heating said hollow interior. The cooking system is operable in a plurality of modes including a wet cooking mode and a dry cooking mode and the heating element is energized in both the wet cooking mode and the dry cooking mode.

In addition to one or more of the features described above, or as an alternative, in further embodiments comprising a lid movable relative to said housing.

In addition to one or more of the features described above, or as an alternative, in further embodiments comprising a liquid source arranged in fluid communication with one of said housing and said lid.

In addition to one or more of the features described above, or as an alternative, in further embodiments said heating element is positioned within said lid.

In addition to one or more of the features described above, or as an alternative, in further embodiments including a food container receivable in said hollow interior, wherein food is receivable in said food container in both said wet cooking mode and said dry cooking mode.

In addition to one or more of the features described above, or as an alternative, in further embodiments the heating element is disposed at or above an upper extent of said food container.

In addition to one or more of the features described above, or as an alternative, in further embodiments including a fan disposed with said heating element at or above said upper extent of said food container.

In addition to one or more of the features described above, or as an alternative, in further embodiments comprising an insert for supporting the food item in either said wet cooking mode or said dry cooking mode.

In addition to one or more of the features described above, or as an alternative, in further embodiments said insert is receivable within said food container.

In addition to one or more of the features described above, or as an alternative, in further embodiments said cooking device is transformable between said wet cooking mode and said dry cooking mode without removing the food item from said hollow interior.

In addition to one or more of the features described above, or as an alternative, in further embodiments said heating element is a convective heating element.

In addition to one or more of the features described above, or as an alternative, in further embodiments said heating element is a conductive heating element.

In addition to one or more of the features described above, or as an alternative, in further embodiments said heating element is a radiative heating element.

In addition to one or more of the features described above, or as an alternative, in further embodiments said heating element is an inductive heating element.

According to another embodiment, a method for cooking food in a cooking system including providing a housing having with a hollow interior, providing a heating element for heating said hollow interior, operating said heating element to cook food in a wet cooking mode, and operating said heating element to cook food in a dry cooking mode.

In addition to one or more of the features described above, or as an alternative, in further embodiments comprising providing a lid movable relative to said housing.

In addition to one or more of the features described above, or as an alternative, in further embodiments said heating element is disposed within said lid.

In addition to one or more of the features described above, or as an alternative, in further embodiments said wet cooking includes a steam cooking operation and said dry cooking mode include an air fry cooking operation.

In addition to one or more of the features described above, or as an alternative, in further embodiments said wet cooking mode further comprises supplying a liquid to a cooking chamber at least partially defined by said hollow interior during operation of said heating element.

In addition to one or more of the features described above, or as an alternative, in further embodiments said wet cooking mode further comprises converting said liquid to a vapor within said cooking chamber.

In addition to one or more of the features described above, or as an alternative, in further embodiments including receiving a food container receivable in said hollow interior, and operating said heating element to cook food in said food container in both said wet cooking mode and said dry cooking mode.

In addition to one or more of the features described above, or as an alternative, in further embodiments operating said heating element to cook food in said dry cooking mode further comprises operating said heating element to convectively heat an interior of said food container to cook food from an area at or above an upper extent of said food container.

In addition to one or more of the features described above, or as an alternative, in further embodiments including moving heated air into said hollow interior of said food container via a fan disposed at or above an opening at an upper extent of said food container.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1 is a schematic diagram of the cooking system according to an embodiment; and

FIG. 2 is a schematic diagram of the control system of the cooking system according to an embodiment;

The detailed description explains embodiments of the disclosure, together with advantages and features, by way of example with reference to the drawings.

### DETAILED DESCRIPTION

With reference to the FIGS., a cooking system 20 configured to perform multiple cooking operations is illustrated. As shown, the cooking system 20 includes a housing 22 and a lid 24 permanently or removably attached, such as hinged for example, to the housing 22. In the illustrated, non-limiting embodiment, the connection or hinge area between the lid 24 and the housing 22 occurs at an upper portion of the housing 22. A bottom 28 of the housing 22 of the cooking system 20 may be supported on a surface by one or more feet 30 which may include shock absorbing pads 30a (of a material such as but not limited to rubber) at a bottom surface thereof. In the illustrated, non-limiting embodiment, the housing 22 includes two feet 30 arranged on opposing sides of the housing 22; however, it should be understood that a housing 22 having any suitable number of feet 30 is within the scope of the disclosure.

In the illustrated, non-limiting embodiment, one or more handles 32 extend outwardly from the exterior of the housing 22 to provide a user with a location to more easily grasp the cooking system 20. Although two handles 32 are shown, embodiments having no handles, a single handle, or more than two handles are also within the scope of the disclosure. The housing 22 and/or the one or more handles 32 may be integrally or separately formed, such as from a molded plastic material for example.

Referring now to some of the interior features of the cooking system 20, an inner surface of the housing 22 defines a hollow interior 34. In an exemplary non-limiting embodiment, a liner 36 that may be formed from any suitable conductive material, such as aluminum for example is disposed within the hollow interior 34, and in some embodiments the liner 36 may be the inner surface defining the hollow interior 34 (though surfaces inside the liner 36, such as the walls of the container, or outside the liner 36, such as plastic around the liner 23, may also define the hollow interior 34). In an exemplary, non-limiting embodiment, a food container 38 is receivable inside the hollow interior 34 defined by the liner 36. Spacing components, such as silicone bumpers (not shown) may be disposed along the inner surface of the liner 36 to keep the container 38 aligned properly within the hollow interior 34 during cooking. Although the container 38 is described herein as being removable from the housing 22, embodiments where the container 38 is integrally formed with the housing 22 are also contemplated herein. The container 38, which is best shown in FIGS. 3 and 4, has an interior 40 designed to receive and retain one or more consumable products, such as food products for example, therein. Examples of food products suitable for use with the cooking system 20, include but are not limited to, meats, fish, poultry, bread, rice, grains, pasta, vegetables, fruits, and dairy products, among others. The container 38 may be a pot formed from a ceramic, metal, or die cast aluminum material. In an embodiment, an interior surface 42 of the container 38 includes a nano-cerarnic coating and an exterior surface 44 of the container 38 includes a silicone epoxy material. However, any suitable material capable of withstanding the high temperatures and pressures required for cooking food products is contemplated herein.

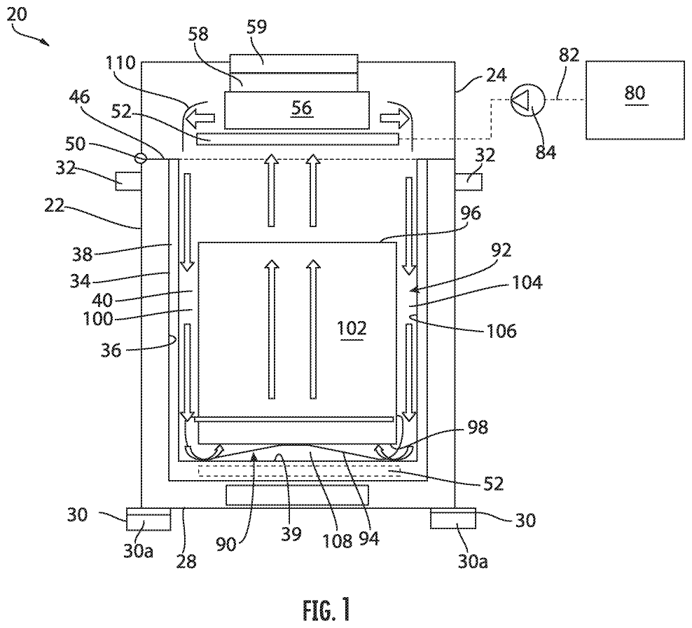

Referring with more detail to the lid 24, it should be noted that the lid 24 is connectable to a surface of the container 38 and/or housing 22 to close off entry to the interior 40 of the container 38. Accordingly, a cooking chamber may be defined between the interior 40 of the container 38 and the interior of the lid 24, to alternatively, between the hollow interior 34 defined by the liner 36 and the interior of the lid 24. In an embodiment, a diameter of the lid 24 is generally complementary to a diameter of the housing 22 such that the lid 24 covers not only the container 38, but also an upper surface 46 of the housing 22. The lid 24 can be made of any suitable material, such as glass, aluminum, plastic, or stainless steel for example. Further, the lid 24 may, but need not, include one or more handles 48 for removably coupling the lid 24 to the remainder of the cooking system 20. In the illustrated, non-limiting embodiment, the lid 24 is coupled to the housing 22 via a hinge 50 such that the lid 24 is rotatable about an axis X between an open position and a closed position (FIG. 1). In such embodiments, the hinge axis X may be located at a side surface of the cooking system 20, or alternatively, at a back surface of the cooking system 20, such as vertically disposed relative to one or more handles 32 of the housing 22. However, embodiments where the lid 24 is separable from the housing 22, or movable between the open and closed positions in another manner are also contemplated herein. One or more fastening mechanisms (not shown may, but need not be used to secure the lid 24 to the housing 22 when the lid 24 is in the closed position. Any suitable type of fastening mechanism capable of withstanding the heat associated with the cooking system 20 is considered within the scope of the disclosure.

The cooking system 20 includes at least one heating element 52 for heating the cooking chamber defined between the interior 40 of the container 38 and the lid 24, or alternatively, between the hollow interior of the liner 36 and the lid 24. The at least one heating element 52 is positioned generally at or above an upper extent 54 of the container 38, proximate an upper opening of the container 38. In the illustrated, non-limiting embodiment shown in the FIGS., the at least one heating element 52 is disposed in the lid 24, and therefore is completely outside of the container 38, when the lid 24 is in the closed position. However, embodiments where the lid 24 is contoured such that the at least one heating element 52 is positioned at least partially within the container 38 are also within the scope of the disclosure.

Further, the cooking system 20 may, but need not, additionally include other heating elements 52 positioned within the housing 22. For example, one or more heating elements, illustrated schematically in broken lines, may be located generally adjacent the bottom 28 of the housing 22 and/or adjacent a sidewall of the housing 22. However, embodiments where the cooking system 20 includes only the at least one heating element 52 arranged above generally adjacent or above the upper extent 54 of the container 38 are also within the disclosure.

In the illustrated, non-limiting embodiment, an air movement device 56, such as a fan for example, is selectively operable to circulate a flow of liquid, for example air, through the cooking. In the illustrated, non-limiting embodiment, the air movement device 56 is driven by a motor 58 having a separate cooling mechanism 59 coupled thereto. The air movement device 56 is operable to circulate air within the cooking chamber through the at least one heating element 52. As the air passes over the at least one heating element 52, the air is heated for cooking the food within the cooking chamber. In an embodiment, the air movement device is also mounted within the lid 24, such as at a position vertically offset from the at least one heating element 52 for example. However, other configurations of the air movement device 56 relative to the at least one heating element 52, for example a concentric arrangement of the air movement device 56 and the at least one heating element 52 are also contemplated herein.

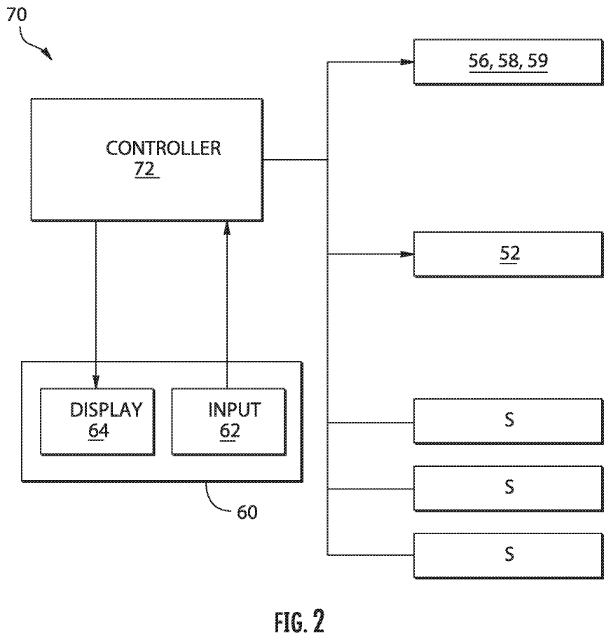

As best shown in FIG. 2, a control panel or user interface 60 of the cooking system 20 is positioned adjacent one or more sides of the housing 22. The control panel 60 includes one or more inputs 62 associated with energizing the at least one heating elements 52 of the cooking system 20 and for selecting various modes of operation of the cooking system 20. One or more of the inputs 62 may include a light or other indicator to show that the respective input has been selected. The control panel 60 may additionally include a display 64 separate from and associated with the at least one input 62. However, embodiments where the display 64 is integrated into the at least one input 62 are also contemplated herein.

Operation of the one or more inputs 62 will be described in more detail below. A control system 70 of the cooking system 20 includes a controller or processor 72 for controlling operation of the at least one heating element 52 and operation of an air movement device 56 (including the motor 58 and fan 59 associated therewith). In some embodiments the control system 70 is additionally capable of executing stored sequences of heating operation. The processor 72 is operably coupled to the control panel 60, the at least one heating element 52, and the air movement device 56.

In addition, in an embodiment, one or more sensors S for monitoring one or more parameters (such as temperature, pressure, lid configuration, etc.) associated with operation of the at least one heating element 52 may be arranged in communication with the processor 72. In an embodiment, a sensor S may be used to monitor whether the lid 24 is in a closed configuration. Alternatively, or in addition, a sensor S may be used to monitor a temperature within the chamber defined between the interior 40 of the container 38 and the lid 24.

In an embodiment, at least one input 62 on the control panel 60 is an on/off button which allows the user to activate or deactivate the control panel 60. When the control panel 60 is deactivated, the at least one heating element 52 is not energized. In an exemplary embodiment, the at least one input 62 is operable to select one or more manual modes of operation of the at least one heating element 52. Alternatively, or in addition, at least one input 62 is operable to select a stored sequence of operation of at least one heating element. In some cases, the stored sequences may be particularly well suited for a given method of food preparation and/or for particular ingredients or types of ingredients. The plurality of stored sequences associated with the at least one input 62 may be stored within a memory accessible by the processor 72. Alternatively, the plurality of stored sequences may be stored remotely from the cooking system 20, and may be accessed by the processor 72, such as via wireless communication for example.

In addition, a user may be able to enter a time associated with operation of the cooking system 20 in a desired manual mode. The time may be entered via the same input 62, or a separate input as used to select a mode of operation. Further in embodiments where the cooking system 20 is in a mode configured to perform a stored sequence in response to selection of one of the inputs 62, the display 64 may indicate a time remaining on the display 64. Temperature and pressure parameters may also be entered via inputs 62.

The at least one input 62 may include a distinct start button intended to initiate operation in a desired mode, a distinct stop button to cease all operation, or a stop/start button intended to initiate and cease functions. Alternatively, the cooking system 20 may be operable to automatically start operation after a predetermined time has elapsed once an input 62 has been selected and any necessary information has been provided to the control panel 60. Alternatively, one or more of the other inputs 62, such as the knob for example, may be operable, such as by pushing the knob towards the control panel 60, to start and stop operation of the cooking system 20, regardless of whether the cooking system 20 is following a stored sequence or is in a manual mode.

The one or more inputs 62 are operable to initiate manual operation of the cooking system 20 in at least a first cooking mode and a second cooking mode. Both the first cooking mode and the second cooking mode use the at least one heating element 52 to perform a convective cooking operation. In an embodiment, the first cooking mode is a wet cooking operation, such as a steam cooking operation for example. To create a wet cooking environment the majority of the moisture within the container, i.e. fluid added to the container 38 is retained within the container 38 as the food is cooked.

During operation in the first cooking mode, a fluid, such as water for example, is provided to the cooking chamber and is transformed from a liquid state to a gaseous or vapor state via the heat output by the at least one heating element 52. In an embodiment, a fluid source, illustrated schematically at 80, is arranged in fluid communication with the cooking system 20. The fluid source 80 may include a reservoir mounted at an exterior of the cooking system 20 capable of storing a volume of fluid therein. The reservoir may be mounted directly to an exterior surface of the cooking system 20, or may be located remotely therefrom. Alternatively, the cooking system 20 may be directly connected to a fluid source 80 integrated with a building, such as a water line. In yet another embodiment, the fluid source may be located within the interior of the cooking system 20, remote from the cooking chamber.

A fluid conduit 82 extends from the fluid source 80 through the cooking system 20, towards the cooking chamber and/or the at least one heating element 52. Depending on the position of the fluid source 80, the fluid conduit 82 may extend through either the lid 24 and/or the housing 22. In some embodiments, such as where the fluid source is disposed vertically above the at least one heating element 52, fluid is configured to flow through the fluid conduit 82 toward the cooking chamber and at least one heating element 52 via gravity. In other embodiments, the cooking system 20 may include a pump 84 for moving fluid from the fluid source through the fluid conduit 82. In embodiments including a pump 84, the pump 84 may similarly be controlled by the processor 72. Regardless of the configuration of the fluid source 80 and how fluid is propelled through the fluid conduit 82, the fluid exits the fluid source 80 as a liquid, and in some embodiments, the fluid is provided to the interior of the cooking system 20 as a liquid.

The fluid from the fluid source 80 is configured to vaporize when heat from the at least one heating element 52 is transferred thereto. In an embodiment, the end of the fluid conduit arranged adjacent the cooking chamber and the at least one heating element 52 is configured to atomize the fluid provided thereto. As a result, the fluid is expelled in the form of droplets or a spray rather than a stream of fluid. The fluid is delivered to an area adjacent at least one of the heating element 52 and/or the air movement device 56.

Accordingly, during a steam cooking operation, the processor 72 initiates operation of the at least one convective heating element 52 causing the temperature within the container 38 to increase. Similarly, the processor may initiate a flow from the fluid source 80 to through the fluid conduit 82, such as via pump 84, or by opening a valve associated with the fluid conduit 82. If the fluid from the fluid source 80 directly contacts the at least one heating element 52, the heat is almost instantaneously transferred to the fluid causing it to vaporize. In embodiments, where the fluid is expelled near the air movement device 56, the fluid may become entrained within the air circulating through the cooking chamber. As a result, when the air and fluid is heated as it passes over the at least one heating element 52, causing the fluid becomes a gas, such as water vapor or steam. This transformation of a liquid to a vapor performed within the cooking chamber in response to the heat generated by the at least one heating element 52 causes not only the pressure, but also the humidity within the cooking chamber to increase.

Although an air movement device 56 is illustrated and described with respect to the heating element 52 and operation of the cooking system 20 in the first cooking mode, embodiments where the air movement device 56 is non-operation in the first cooking mode are also contemplated herein. Accordingly, in such embodiments, the heating element mounted within the lid 24 may be a conductive, inductive, or radiative heating element in place of the previously described convective heating element. In such embodiments, the interaction of the fluid from the fluid source with the heating element 52, or alternatively, the area adjacent the heating element, may cause the fluid to transform from a liquid to a vapor.

As previously suggested, the at least one input 62 may also be used to select operation of the cooking system 20 in a second cooking mode. During operation in the second cooking mode, the at least one heating element performs a “dry cooking operation,” which includes any cooking mode that creates a “dry cooking environment” within the container 38. To create a dry cooking environment, air and/or moisture are actively exhausted or vented from the cooking chamber to outside the cooking system 20, thereby maintaining a minimum level of moisture within the container 38. In an embodiment, the second cooking mode includes a frying cooking operation, and more specifically an air frying operation. An air frying operation may involve the use of various components such as the air movement mechanism 56, a diffuser 90 and an insert 92.

An example of an air diffuser 90 suitable for use with the cooking system 20 is shown in FIG. 1. The diffuser 90 is an optional system component that may benefit air circulation during the air frying mode. However, it should be understood that the diffuser 90 may similarly be installed within the cooking chamber during operation in the first cooking mode. The diffuser 90 is positionable anywhere within the cooking chamber, though typically near a bottom thereof. In an embodiment, the diffuser 90 is positioned in contact with a bottom surface 39 of the container 38, and, as will be discussed in greater detail below, used in conjunction with an insert 92.

The air diffuser 90 may include a plurality of vanes 94 configured to impart swirl to an air flow circulating through the container 38. In an embodiment, each of the vanes 94 of the air diffuser 90 has a radius of curvature such that the vanes 94 curve generally from a center of the air diffuser 90 outwardly. In addition, the vanes 94 of the air diffuser 90 extend generally perpendicularly in an upward direction from the bottom surface 39 of the container 38, and a lower extent of the vanes 94 generally increases over the length of the vane. However, an air diffuser 90 including one or more vanes 94 having another configuration are also within the scope of the disclosure.

In an exemplary, non-limiting embodiment, the vanes 94 cooperate to define an area within which the insert 92 may be removably mounted. With, the insert 92 includes a body having a first, open end 96, second, aperture end 98, and at least one sidewall 100 extending between the first end 96 and second end 98 to define a hollow interior or chamber 102. The first end 96 is generally open to provide access for positioning one or more food items within the chamber 102. The second end 98 of the insert is partially closed to retain one or more food items within the chamber 102. In the, non-limiting embodiment, the closed second end 98 of the body defines a plurality of apertures to allow air, heat, and/or steam flowing within/through the interior 40 of the container 38 to pass there through to cook one or more food items within the chamber 102.

When the insert 92 is mounted to the air diffuser 90, and positioned within the interior 40 of the container 38, the bottom surface 98 of the insert 92 is offset from the bottom surface 39 of the container 38. The offset spacing occurs due to the vanes 94, thereby allowing air moving through the cooking system 20 to flow underneath the insert 92. Embodiments wherein the diffuser 90 is integrally formed with either the insert 92 or bottom surface 39 and/or side surfaces of the container 38 are also contemplated. Further, although insert 92 is illustrated having a single chamber 102, embodiments where the insert 92 includes a plurality of chambers 102 are also contemplated herein.

When the insert 92 and air diffuser 90 are arranged within the cooking chamber, an annulus 104 is formed between an inner surface 106 of the container 38 and the sidewalls 100 of the insert 92. Further, in an exemplary non-limiting embodiment the height of the insert 92, when installed within the container 38 with the air diffuser 90, may be generally equal to or less than height of the container 38.

It should be appreciated that the insert 92 may also be received directly in the hollow interior 34 of the housing 22 as opposed to within the interior 40 of the container 38. That is, the insert 92 (and diffuser 90) may be disposed in the cooking system 20 without the container 38, and food may be cooked in the insert 92 in accordance with the second mode cooking functions.

During operation in the second cooking mode, the at least one heating element 52 is configured to heat air as it passes there through via operation of the air movement device 56. In embodiments where the insert 92 is arranged within the cooking chamber, the air movement device 56 draws air from the center of the insert 92, and moves it across the at least one heating element 52 before forcing the heated air through the annulus 104 between the container 38 and the insert 92 towards a clearance 108 formed between the bottom 98 of the insert 92 and the bottom surface 39 of the container 38 (see arrows in FIG. 1 indicating the direction of air flow through the cooking system 20 during a second cooking operation). Although use of the diffuser 90 and insert 92 are described herein, it should be understood that the at least one heating element 52 and air movement device 56 may also be used to circulate air through the cooking chamber defined between the container 38 and the lid 24 when the insert 92 and/or air diffuser 90 are not arranged within the container 38.

In an embodiment, the at least one heating element 52 has a diameter substantially equal to the diameter of the body 104 of the insert 92. However, embodiments where the at least one heating element 52 has a diameter smaller than or greater than the diameter of the insert 92 are also contemplated herein.

When utilizing the at least one heating element 52 in the air fryer mode, the processor 72 initiates operation of the at least one heating element 52 and the air movement device 56 to circulate the hot air represented by the arrows in FIG. 1 through the cooking chamber. The air movement device 56 draws air upward through the at least one heating element 52 and expels the hot air outwardly towards a guide 110 (which, in an embodiment, actually surrounds the air movement device 56). The guide 110 may be configured to deflect the air flow downwardly towards the annulus 104 along the sides of the container 38. The air travels down through the annulus 104 by actuation of the air movement device 56 until it is deflected off the bottom surface 39 of the container 38 and drawn up into the clearance 108 up towards the diffuser 90 and end 98 of the insert 92. The hot air flows over and between the plurality of vanes 94 of the air diffuser 90, which impart a rotational motion to the hot air, thereby creating a vortex as the air is drawn through the apertures at the second end 98 and into the chamber 102 of the insert 92 by the air movement device 56. After traversing the chamber 102, the air is drawn back up through the heating element 52 and into the air movement device 56 for further circulation.

As the air circulates through the chamber 102 in the manner described above, the hot air cooks and forms a crispy outer layer on the food items disposed therein as a result of the Maillard effect. In an embodiment, a liquid, such as oil or fat, is contained within the cooking chamber, such as adjacent the bottom surface 39 of the container 38. The liquid may be added to the container 38 prior to operation in the air fry mode, or alternatively, may be produced as a residual material as the hot air passes over the food within the chamber 102. In embodiments where a liquid is disposed at the bottom of the container 38, as the air circulates through the interior 40 of the container 38, a portion of the liquid becomes entrained in the air flow and is heated.

In an embodiment, the air movement device 56 of the cooking system 20 is a variable speed fan operable at a plurality of rotational speeds. In an embodiment, the operational speed of the air movement device 56 may vary based on the cooking mode selected. For example, the speed of the air movement device 56 during operation in an air fryer mode may be different than the speed of the air movement device during operation in a steam cooking mode. The operational speed of the air movement device 56 may be controlled by the processor 72 in response to one or more inputs 62, including selection of a cooking mode. However, the processor 72 may also be configured to adjust the operational speed of the air movement device 56, or alternatively, the power supplied to the at least one heating element 52 to control the temperature and/or pressure within the cooking chamber.

In some embodiments, the cooking system 20 is operable in more than two cooking modes. For example, the at least one input 62 may be used to select operation of the cooking system 20 in a cooking mode that functions as a combination of two or more cooking modes. In such embodiments, the processor 72 may execute a stored sequence where the at least one heating element 52 is operated with a first set of parameters during a first portion of the sequence and at least one heating element 52 is operated and air movement device 56 are operated with a second set of parameters during a second portion of the sequence. For example, in the combination mode, a food item, such as a chicken for example, may first be steam cooked via operation in the first cooking mode, and then air fried to form a crispy exterior layer via operation of the cooking system 20 in the second cooking mode. However, the embodiments described herein are intended as an example only and any sequence of operation combining both the first and second cooking mode is contemplated herein. When operated in a combination of two or more cooking modes, the food need not be removed from the cooking chamber or hollow interior 40, during such a transition.

In accordance with the above, the insert 92 may be placed in the container 38 with food to be cooked in the first and second modes consecutively. For example, the insert 92 may be placed in the container 38 and food may be placed within the insert 92 for cooking in a first steam cooking mode. The cooking system 20 may then be switched into the second, air fry mode, and the food still contained in the insert 92 positioned within the container 38 can be cooked in accordance with a convection heating function. In an embodiment, such a process would involve placing food in the insert 92 and placing the insert 92 in the interior 40 of the container 38. Of course, while food would most commonly be cooked first wet mode followed by a second dry mode, the cooking system 20 is certainly capable of cooking food first in a dry mode followed by a wet mode.

The cooking system 20 illustrated and described herein provides an enhanced user experience by combining the functionality of several conventional household products into a single user-friendly device.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The invention claimed is:

1. A cooking system for cooking food, the cooking system comprising:
a housing having a hollow interior;
a lid movable relative to said housing, wherein said lid and said housing cooperate to form a cooking chamber;
a liquid source for delivering liquid to said cooking chamber during operation of the cooking system; and
a heating element mounted within said lid, said heating element being operable to transform said liquid into a vapor during operation of the cooking system.

2. The cooking system of claim 1, wherein said liquid source is external to said housing and said lid.

3. The cooking system of claim 2, wherein said liquid source includes a reservoir mountable to at least one of said housing and said lid.

4. The cooking system of claim 2, wherein said liquid source is a fluid line integrated within a building.

5. The cooking system of claim 1, wherein said liquid is water.

6. The cooking system of claim 1, wherein said cooking system is operable in a plurality of cooking modes including a first cooking mode and a second cooking mode, wherein said first cooking mode is a wet cooking mode and said second cooking mode is a dry cooking mode.

7. The cooking system of claim 6, wherein in said first cooking mode, said liquid is transformed into a vapor during operation of the cooking system.

8. The cooking system of claim 6, wherein in said first cooking mode, the cooking system is operable as a steam cooker.

9. The cooking system of claim 6, wherein in said second cooking mode, said heating element heats a flow of air circulating within the cooking chamber.

10. The cooking system of claim 6, wherein in said second cooking mode, the cooking system is operable as an air fryer.

11. The cooking system of claim 5, wherein said heating element is operable in both said first cooking mode and said second cooking mode.

12. The cooking system of claim 1, wherein said heating element is a convective heating element.

13. The cooking system of claim 1, wherein said heating element is a conductive heating element.

14. The cooking system of claim 1, wherein said heating element is a radiative heating element.

15. The cooking system of claim 1, wherein said heating element is an inductive heating element.

16.-20. (canceled)

21. A cooking system for cooking food, the cooking system comprising:
a housing having a hollow interior; and
a heating element for heating said hollow interior;
wherein the cooking system is operable in a plurality of modes including a wet cooking mode and a dry cooking mode and the heating element is energized in both the wet cooking mode and the dry cooking mode.

22. The cooking system of claim 21, further comprising a lid movable relative to said housing.

23. The cooking system of claim 22, further comprising a liquid source arranged in fluid communication with one of said housing and said lid.

24. The cooking system of claim 22, wherein said heating element is positioned within said lid.

25. The cooking system of claim 21, further including a food container receivable in said hollow interior, wherein food is receivable in said food container in both said wet cooking mode and said dry cooking mode.

26. The cooking system of claim 25, wherein the heating element is disposed at or above an upper extent of said food container.

27. The cooking system of claim 25, further including a fan disposed with said heating element at or above said upper extent of said food container.

28. The cooking system of claim 21, further comprising an insert for supporting the food item in either said wet cooking mode or said dry cooking mode.

29. The cooking system of claim 28, wherein said insert is receivable within said food container.

30. The cooking system of claim 21, wherein said cooking device is transformable between said wet cooking mode and said dry cooking mode without removing the food item from said hollow interior.

31. The cooking system of claim 21, wherein said heating element is a convective heating element.

32. The cooking system of claim 21, wherein said heating element is a conductive heating element.

33. The cooking system of claim 21, wherein said heating element is a radiative heating element.

34. The cooking system of claim 21, wherein said heating element is an inductive heating element.

35.-43. (canceled)
